(19) United States
(12) Patent Application Publication
(10) Pub. No.: US 2004/0141555 A1
(43) Pub. Date: Jul. 22, 2004

(54) Method of motion vector prediction and system thereof

(76) Inventors: Patrick M. Rault, Toronto (CA); Zhihua Zeng, North York (CA)

Correspondence Address: TOLER & LARSON & ABEL, L.L.P., 5000 PLAZA ON THE LAKE, AUSTIN, TX, 78746, US

(21) Appl. No.: 10/345,710

(22) Filed: Jan. 16, 2003

(51) Int. Cl. H04N 7/12

(52) U.S. Cl. 375/240.16; 375/240.12; 348/699

(57) ABSTRACT

A first set of motion vectors associated with a first frame of video data is determined. A second set of motion vectors associated with a second frame of video data is also determined. A motion vector for a pixel set associated with the second frame of video data is predicted based upon the first set of motion vectors and the second set of motion vectors. In one embodiment, the first frame of video data is a frame of pixel data that was encoded prior to the second frame. The first frame may also be a frame to be displayed prior to the second frame of video data.

### FIELD OF THE DISCLOSURE

The present invention relates generally to processing of video data, and more particularly to a method of motion vector prediction.

### BACKGROUND

Digital video protocols employing algorithms for the compression of video data are commonly known and used. Examples of protocols used to compress digital video data are a set of protocols put forth by the Motion Picture Experts Group (MPEG) referred to as MPEG2 and MPEG4 protocols. The MPEG protocols refer to. During a compression, or encoding process, these protocols attempt to specify how to take advantage of redundant image portions from previous frames. One compression technique used to accomplish this compression is to provide a motion vector for a frame portion being encoded that indicates where in a previously displayed frame a similar image portion is located. By providing a motion vector to a previously displayed image portion that is substantially similar, only the difference between the two images needs to be stored, thereby significantly reducing the amount of data needing to be transmitted or stored.

The process of identifying substantially similar image portions in a previous frame with an image portion being encoded is a computationally intensive process. Therefore, an attempt is made to estimate where a substantially similar frame will be located. This estimation is referred to as motion vector prediction. Known methods of motion vector prediction use a motion vector from a previously encoded portion of the current frame as the predicted motion vector for the current portion being encoded. Techniques which would improve the motion vector prediction would be useful in that the subsequent encoding process time can be reduced.

### BRIEF DESCRIPTION OF THE DRAWINGS

FIG. 1 illustrates a representation of video data in accordance with the prior art;

FIG. 2 illustrates graphically multiple frames of video data being used to determine a predicted motion vector in accordance with a specific embodiment of the disclosure;

FIGS. 3 and 4 illustrate flow diagrams in accordance with specific methods of the present disclosure; and

FIG. 5 illustrates in block diagram form, a system in accordance with the present invention.

### DETAILED DESCRIPTION OF THE FIGURES

In the present disclosure, a first set of motion vectors associated with a first frame of video data is determined. A second set of motion vectors associated with a second frame of video data is also determined. A motion vector for a pixel set associated with the second frame of video data is predicted based upon the first set of motion vectors and the second set of motion vectors. In one embodiment, the first frame of video data is a frame of pixel data that was encoded prior to the second frame. The first frame may also be a frame to be displayed prior to the second frame of video data.

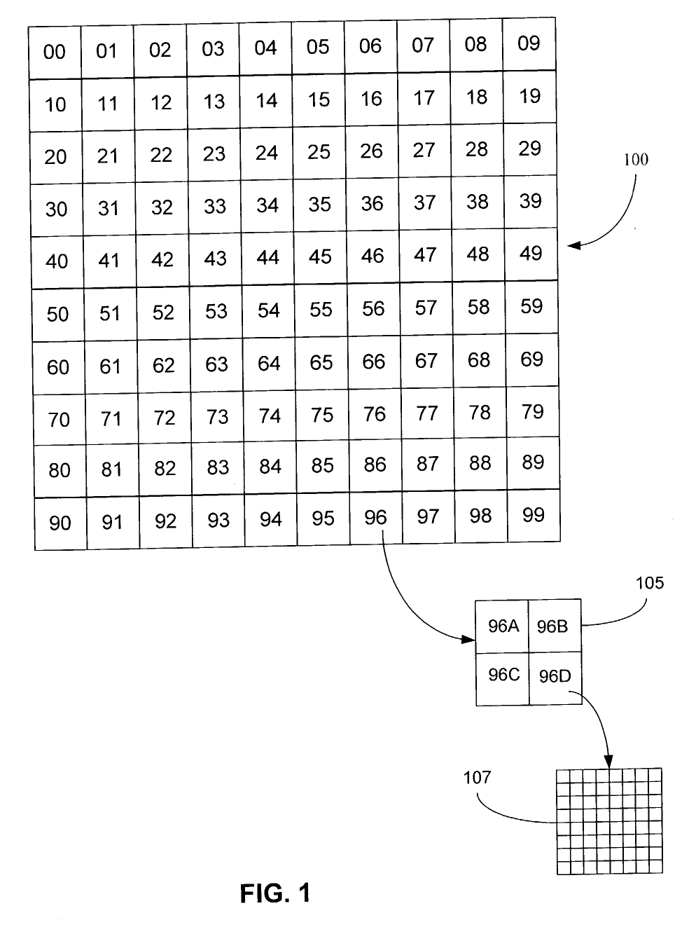

FIG. 1 is used to identify, for purpose of clarity, the nomenclature used herein. Specifically, FIG. 1 illustrates two frames of data 102 and 103. Frame 103 is identified as being the current frame of video as represented by the nomenclature T(0). Using similar nomenclature, the frame 102 is identified as being the previous frame of the video as represented by the indicator T(−1). It will be appreciated, that with respect to an encoding process, the frame 102 will have been previously encoded during a previous time period. Likewise, the indicator of T(0) for frame 103 indicates that frame 103 is the frame currently being encoded.

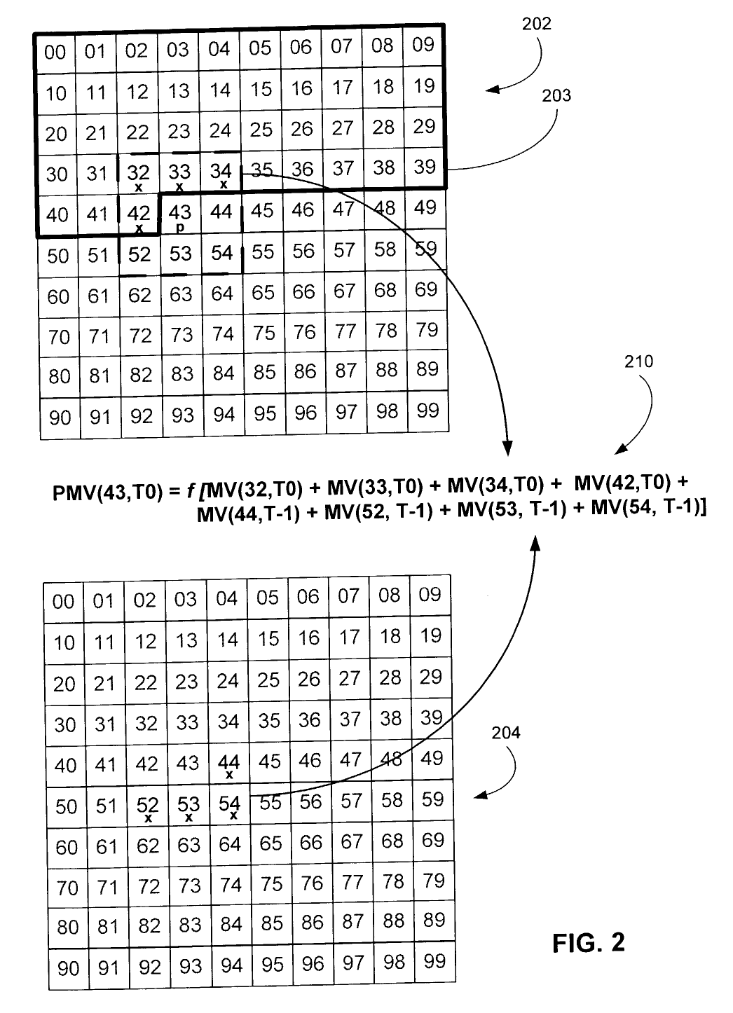

A more detailed view of frame 103, or any frame, is represented by the frame map 100. Specifically, frame map 100 illustrates that the frame 103 is made up of multiple pixel sets numbered 00 through 99. According to MPEG protocol, the pixel sets 00 through 99 would be referred to as macroblocks. Each macroblock, as indicated specifically with respect to macroblock 96, is made up of four blocks of data. Each of the blocks of data comprises an eight by eight pixel array as indicated by pixel array 107. For purpose of illustration, the term macroblock will be used herein to indicate a specific pixel set being encoded. However, it will be appreciated that other pixel sets besides macroblock may be used for the encoding process described herein. For example, the encoding process could occur on a block by block basis, or some other pixel set size. In addition, even though the terminology generally used herein is consistent with terminology of the MPEG protocols, the methods and systems described herein would be equally applicable to other systems and methods using compression techniques that implement the use of motion vectors. Specific embodiments of the present disclosure will be better understood with reference to FIGS. 2-5.

FIG. 2 illustrates a frame 202 being currently encoded, and pixel data for a previously encoded frame 204. During the encoding process, each macroblock in the frame 202 is compressed by correlating its pixels to pixels of the previous frame 204. Note that the previous frame 204, to which the macroblocks of frame 202 are correlated, is a reference frame. In other words, the macroblocks of the frame 202 are correlated to the pixels of the reference frame where the reference frame will be available during a decompression of the current frame. The previous frame is typically going to be encoded prior to the current frame, therefore, the macroblocks of the previously encoded frame 204 will already have compressed data that will include motion vector information.

In accordance with a specific embodiment of the present disclosure, the macroblock 43 of frame 202 is currently being encoded. An indicator “P”, associated with the macroblock 43, indicates that a motion vector is being predicted for the macroblock 43. The region 203 that includes macroblocks 00 through 42 indicates those macroblocks of the current frame 202 having already been encoded. For purpose of discussion it will be assumed that each of the previously encoded macroblocks in the current frame 202 have motion vectors.

In accordance with a specific embodiment of the present disclosure, the macroblock 43, the macroblock currently being encoded, receives a predicted motion vector based upon motion vectors from adjacent macroblocks. The adjacent macroblocks can be adjacent macroblocks within the frame 202, of which the macroblock 43 is a member, or they can be macroblocks in the previous frame 204 that are co-located with macroblocks of frame 202 that are immediately adjacent to the macroblock 43 of frame 202. For example, as indicated by equation 210, the predicted motion vector for macroblock 43 is a function of the motion vectors of macroblocks 32, 33, 34, and 42, all of frame 202 and marked with an “X” in FIG. 2. However, none of the other immediately adjacent macroblocks in frame 202 have been encoded, and therefore do not yet have motion vectors. In other words, with respect to the frame 202, the macroblock locations 44, 52, 53, and 54 do not have motion vectors that can be used for motion vector predication.

Instead of predicting the motion vector for macroblock 43 of frame 202 from only those macroblocks in frame 202 that have been encoded, the present disclosure uses motion vectors associated with the co-located macroblocks in the previous frame 204. The locations of the co-located macroblock locations in frame 204 are marked with an “X”. For example, the motion vector for the macroblock 44 of frame 204 is used along with the motion vectors for macroblocks 52-54 of frame 204. In this manner, the predicted motion vector for macroblock 43 of frame 202 is based upon a larger set of previously existing motion vectors. In another embodiment, motion vectors from macroblock locations that are not immediately adjacent can also be used. For example, motion vectors from macroblock locations that are within two macrobocks of macroblock being encoded can be used. In this embodiment the motion vectors of frame 202 at locations 21-25, 31, 35, and 41 can be used in the prediction process. Likewise, the motion vectors of frame 204 at locations 45, 51, 55, and 61-65 could be used in the prediction process.

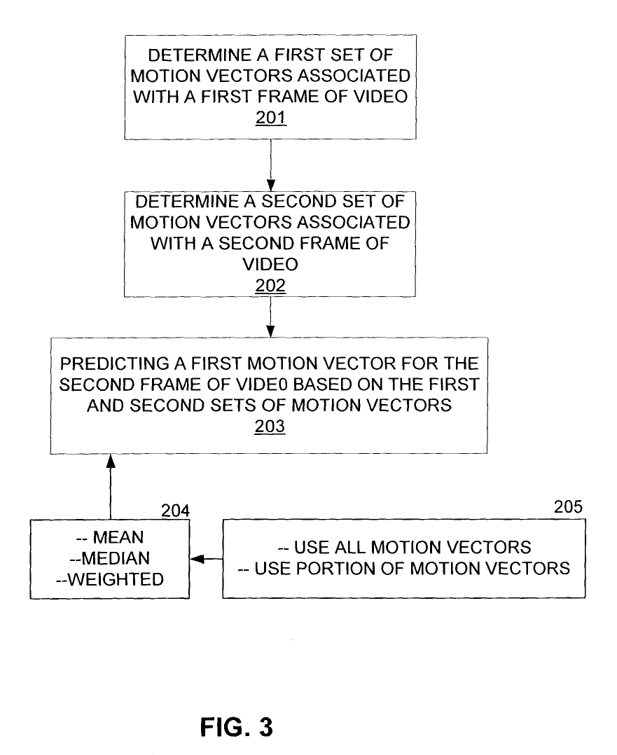

FIG. 3 illustrates, in flow diagram form, a method for predicting a motion vector in accordance with the present disclosure. In step 201, a first set of motion vectors associated with the first frame of video data is determined. Referring to FIG. 2, in one embodiment the first set of motion vectors is associated with frame 202, and would include the motion vectors from macroblocks 32, 33, 34, and 42. Note that this embodiment includes the motion vectors for each macroblock that is immediately adjacent, orthogonally or diagonally, to the macroblock currently being encoded. It will be appreciated that with another embodiment, that only the orthogonal macroblocks that are immediately adjacent to, or the diagonal macroblocks that are immediately adjacent to, the macroblock being encoded would be used. In yet another embodiment, macroblocks that are within two macroblocks of the macroblock being encoded could be used.

At step 202, a second set of motion vectors associated with a second frame of video data is determined. Referring again to FIG. 2, the second set of motion vectors would include the motion vectors from macroblocks 44, 52, 53, and 54 for the frame 204. As indicated previously, the macroblocks included in the second set of motion vectors include those motion vectors of macroblocks in frame 204 that are co-located with macroblocks of frame 202 that are immediately adjacent to the macroblock being encoded. The specific embodiment illustrated includes all immediately adjacent macroblocks that are co-located with an immediately adjacent macroblock of the macroblock being encoded. In other embodiments, only orthogonal or diagonal macroblocks would be considered. In yet another embodiment, macroblocks that are co-located with macroblocks within two macroblocks of the macroblock being encoded could be used.

At step 203 a first motion vector is predicted for the first frame of video data based upon the first and second sets of motion vectors. For example, referring to FIG. 2, the predicted motion vector for the macroblock 43 of frame 202 is predicted based upon the equation 210. It will be appreciated, that once a motion vector predication is made, it may be used as the actual motion vector for the macroblock being encoded, or it can be used as a starting point for a further encoding process to determine a final motion vector to be associated with the macroblock being encoded.

There are numerous ways that a predicted motion vector may be derived using the motion vectors of the first and second sets of motion vectors of steps 201 and 202. One embodiment is to determine a mean of the motion vectors in the first and second sets. A second embodiment would determine a median value of the motion vectors contained within the first and second sets of motion vectors. Yet another embodiment can predict the motion vector by weighting the motion vectors within the sets differently before applying a specific algorithm. In addition, all of the motion vectors within the first and second sets may be used, or only a portion of the motion vectors within the sets may be used. For example, it may be determined that one or more of the motion vectors within the first and/or second sets of motion vectors differs from of most of the other motion vectors in some manner (e.g. magnitude and/or direction), or that it lies outside of some other statistical parameter, such as a standard deviation, that would prevent it from being included in the set.

In the previous discussion, it has been assumed that each of the macroblocks within the frame being encoded, frame 202 and the frame previously encoded, frame 204 have a motion vector. However, it is not always necessary that an encoded macroblock have a motion vector. When an encoded macroblock that is immediately adjacent to the macroblock being encoded does not have a motion vector, several options may be implemented. For example, the set of motion vectors used to generate the predicted motion vector may have one less motion vector. In another embodiment, the set of motion vectors used to predict the predicted motion vector could include a motion vector having a predetermined value, such as (0,0). An alternate option would be to use an alternative motion vector from a neighboring macroblock. For example, if the encoded macroblock 32 of frame 202 did not have a motion vector, the motion vector for one of its immediately adjacent macroblocks could be used instead. In yet another embodiment, when an encoded macroblock in the frame currently being encoded does not have a motion vector associated with it, the motion vector of its co-located macroblock in the frame previously encoded could be used. In a similar manner, when a macroblock that is co-located with a macroblock of the current frame does not have a motion vector, the motion vector could instead be replaced with a motion vector having a predefined value, such as (0,0), or by an alternative motion vector computed by a neighborhood motion vector immediately adjacent to the co-located macroblock.

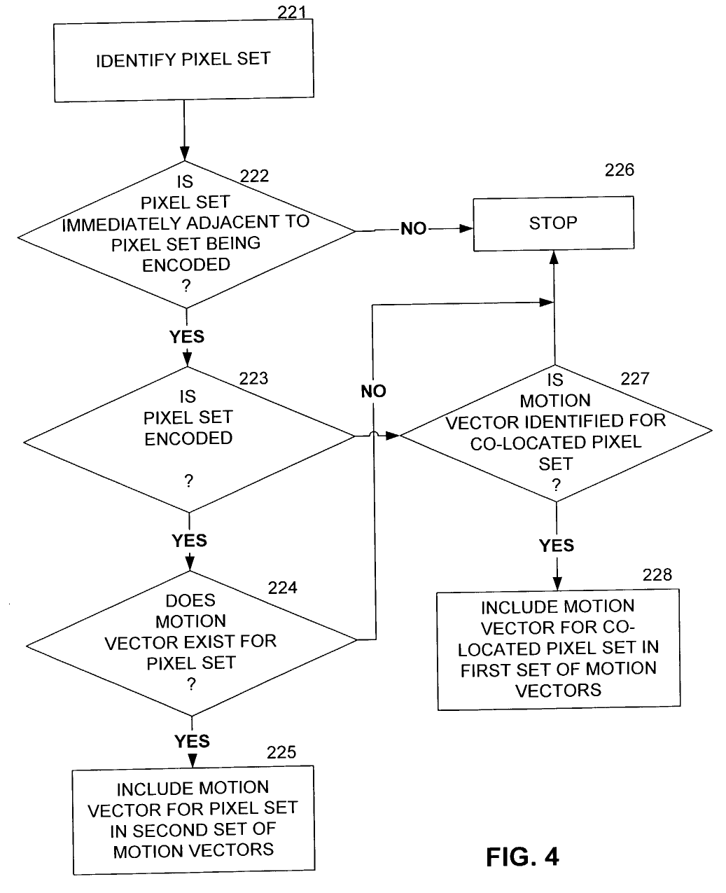

FIG. 4 illustrates, in flow diagram form, a method in accordance with the present disclosure. Specifically, the flow diagram of FIG. 4 illustrates a method of determining the first and second sets of motion vectors of steps 201 and 202 of FIG. 3.

At step 221, a pixel set, such as macroblocks, associated with the frame currently being encoded is identified. Next, at step 222, a determination is made whether or not the pixel set is immediately adjacent to a pixel set being encoded. Note that in other embodiments macroblock further away than the immediately adjacent macroblock could be identified at step 222 for inclusion. With reference to the embodiment of FIG. 2, however, only the macroblocks immediately adjacent to macroblock 43 of frame 203 would result in the flow proceeding from step 222 to step 223. Specifically, if the pixel set is not immediately adjacent to the pixel set currently being encoded, it will not be considered as part of the first or second set of motion vectors and the flow proceeds to step 226 where the flow terminates for that pixel set. If the pixel set is immediately adjacent to the pixel set being encoded the flow proceeds to step 223.

At step 223, a determination is made whether or not the pixel set has been encoded. If the pixel set has not been encoded, such as the pixel set 44 of frame 203 in FIG. 2, the flow proceeds to step 227. Otherwise, when encoded, the flow proceeds to step 224.

At step 224, a determination is made whether or not a motion vector exists for the pixel set. If a motion vector exists for the pixel set the flow proceeds to step 225, where the motion vector is included in the pixel set for the second set of motion vectors, which in FIG. 3 is the set of motion vectors for the frame being currently encoded. However, if a motion vector does not exist for the pixel set the flow proceeds from step 224 to step 226 and no motion vector is included in either of the sets of motion vectors. Note, in an alternate embodiment, the flow from step 224 could proceed to step 227 to determine if a co-location pixel set had a motion vector to be included.

At step 227, a determination is made whether or not a motion vector exists for a co-located pixel set. If a motion vector does exist for a co-located pixel set it is included at step 228 as part of a first set of motion vectors, which is the set of motion vectors for the previously encoded frame. In this manner, the members of the first and second set of motion vectors can be readily determined.

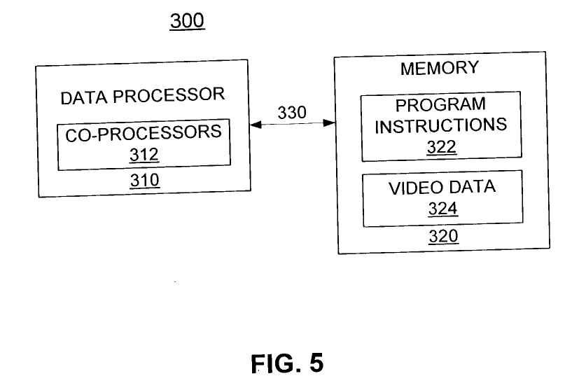

FIG. 5 illustrates a system in accordance with a specific embodiment to the present disclosure. Specifically, FIG. 5 illustrates a system 300 having a data processor 310, and a memory 320. In operation, the data processor 310 accesses the memory 300 to execute program instructions 322 and to operate upon video data 324. For example, the video data 324 would generally include the video frame data of frames 202 and 204 in FIG. 2. Likewise, the video processor 310 would generally comprise an instruction execution unit for implementing the instructions. In addition, the data processor 310 can include co-processors 312, which can include specific hardware, accelerators and/or microcode engines, capable of accelerating the encoding process. In will be further appreciated, that the information processor 300 of FIG. 5 can be part of a general purpose computer, special purpose computer, or integrated as a portion of a larger system.

In the preceding detailed description of the embodiments, reference has been made to the accompanying drawings which for a part thereof, and in which is shown by way of illustration specific embodiments in which the disclosure may be practiced. These embodiments are described in sufficient detail to enable those skilled in the art to practice the disclosure, and it is to be understood that other embodiments may be utilized and logical, mechanical and electrical changes may be made without departing from the spirit or scope of the present disclosure. To avoid detail not necessary to enable those skilled in the art to practice the disclosure, the description may omit certain information known to those skilled in the art. Furthermore, many other varied embodiments that incorporate the teaching of the disclosure may be easily constructed by those skilled in the art. Accordingly, the present disclosure is not intended to be limited to the specific form set forth herein, but on the contrary, it is intended to cover such alternatives, modifications, and equivalents, as can be reasonably included within the spirit and scope of the disclosure. The preceding detailed description is, therefore, not to be taken in a limiting sense, and the scope of the present disclosure is defined only by the appended claims.

What is claimed is:

1. A method comprising the steps of:
determining a first set of motion vectors associated with a first frame of video data;
determining a second set of motion vectors associated with a second frame of video data; and
predicting a first motion vector for a first pixel set of the second frame of video data based on the first set of motion vectors and a the second set of motion vectors.

2. The method of claim 1, wherein determining further comprises the first frame of video data representing an image to be displayed prior to the second frame of video data.

3. The method of claim 1, wherein
determining the first set of motion vectors comprises determining a second motion vector for a second pixel set;
determining the second set of motion vectors comprises determining a third motion vector for a third pixel set; and
predicting comprises predicting the first motion vector using the second motion vector and the third motion vector, wherein the third motion vector is immediately adjacent to the first motion vector in the second frame.

4. The method of claim 3, wherein
predicting comprises predicting the first motion vector wherein the second motion vector is co-located with a fourth pixel set that is immediately adjacent to the first pixel set in the second frame.

5. The method of claim 3, wherein
predicting comprises predicting the first motion vector wherein the second motion vector is co-located with a fourth pixel set that is immediately adjacent to the first pixel set in the second frame.

6. The method of claim 1, wherein determining the first set of motion vectors comprises each motion vector of the first set of motion vectors being co-located with a pixel set immediately adjacent to the first pixel set.

7. The method of claim 6, wherein determining the second set of motion vectors comprises each motion vector of the second set of motion vectors corresponding to a pixel set that is located immediately adjacent to the first pixel set.

8. The method of claim 1, wherein determining the second set of motion vectors comprises each motion vector of the second set of motion vectors corresponding to a pixel set that is located immediately adjacent to the first pixel set.

9. The method of claim 1 wherein determining the first set of motion vectors comprises identifying pixel sets co-located with a pixel set immediately adjacent to the first pixel set.

10. The method of claim 1 wherein determining the first set of motion vectors comprises identifying motion vectors for pixel sets co-located with a pixel set immediately adjacent to the first pixel set.

11. The method of claim 1 wherein predicting the first motion vector comprises determining an average value for the first motion vector based upon the first set of motion vectors and the second set of motion vectors.

12. The method of claim 11, wherein predicting the first motion vector comprises removing a motion vector from the first set of motion vectors when determining the average value.

13. The method of claim 1 wherein predicting the first motion vector comprises determining a mean value for the first motion vector based upon the first set of motion vectors and the second set of motion vectors.

14. The method of claim 13, wherein predicting the first motion vector comprises removing a motion vector from the first set of motion vectors when determining the mean value.

15. The method of claim 1, wherein a pixel set represents an 8×8 block of pixels.

16. The method of claim 1, wherein a pixel set represents a 16×16 block of pixels.

17. A system comprising:
a video data processing element;
a memory coupled to the video data processing element, the memory comprising:
a video data storage region to store a first frame of video data and a second frame of video data; and
a program storage region to store program instructions, the program instructions to facilitate
determining a first set of motion vectors associated with a first frame of video data;
determining a second set of motion vectors associated with a second frame of video data; and
predicting a first motion vector for a first pixel set of the second frame of video data based on the first set of motion vectors and a the second set of motion vectors.

18. The method of claim 17, wherein the program instructions to facilitate determining the first set of motion vectors comprise determining that each motion vector of the first set of motion vectors being co-located with a pixel set immediately adjacent to the first pixel set.

19. The method of claim 17, wherein the program instructions to facilitate determining the second set of motion vectors comprise determining that each motion vector of the second set of motion vectors corresponding to a pixel set that is located immediately adjacent to the first pixel set.

20. A method comprising the steps of:
receiving a first frame of video data having a first pixel set, the first frame of video data to be displayed at a first time;
receiving a second frame of video having a second pixel set and a third pixel set, wherein the second pixel set and the third pixel set are immediately adjacent to each other in one of a horizontal, vertical, or diagonal direction, the first pixel set is co-located with the third pixel set, and the second frame of video data is to be displayed at a second time;
determining a motion vector for the first pixel set; and
determining a motion vector for the second pixel set based upon the motion vector for the first pixel set.

21. The method of claim 20, wherein the receiving the second frame of video comprises the second time being after the first time.

22. The method of claim 21, wherein the step of determining the motion vector for the second pixel set comprises determining the motion vector for the second pixel set based upon the motion vector for the first pixel set when a motion vector for the third pixel set has not been determined.

23. The method of claim 21, wherein the step of determining the motion vector for the second pixel set comprises determining the motion vector for the second pixel set based upon one of
the motion vector for the first pixel set when a motion vector for the third pixel set has not been determined; and
the motion vector for the third pixel set when a motion vector for the third pixel set has been determined.
